(19) United States
(12) Patent Application Publication
(10) Pub. No.: US 2017/0198241 A1
(43) Pub. Date: Jul. 13, 2017

(54) Improved Detergent Composition

(71) Applicant: Reckitt Benckiser (Brands) Limited, Slough (GB)

(72) Inventors: Alias Al-Bayati, Heidelberg (DE); Gerhard Kammerer, Heidelberg (DE); Sabrina Dittmann, Heidelberg (DE)

(73) Assignee: Reckitt Benckiser (Brands) Limited, Slough (GB)

(21) Appl. No.: 15/314,659

(22) PCT Filed: Jun. 1, 2015
(86) PCT No.: PCT/GB2015/051589

§ 371 Date: Nov. 29, 2016

(30) Foreign Application Priority Data
May 30, 2014 (GB) 1409632.5

(51) Int. Cl. C11D 3/37; A47L 15/00; C11D 17/00; C11D 17/04; C11D 3/40; C11D 3/33

(52) U.S. Cl. CPC C11D 3/3723; C11D 3/40; C11D 3/33; C11D 17/003; C11D 17/046; A47L 15/0007

(57) ABSTRACT

The invention relates to a colour stable liquid or gel detergent composition comprising an aminocarboxylate builder, a dye and a polyalkyleneimine.

### TECHNICAL FIELD

The present invention relates to stabilised coloured detergent formulations, especially automatic dishwashing (ADW) formulations, comprising aminocarboxylate builders and dyes.

The present invention also relates to the use of polyalkyleneimines to stabilize gel or liquid formulations comprising aminocarboxylate builders and dyes.

### BACKGROUND

Aminocarboxylates such as methylglycine-N,N-diacetic acid (MGDA) and L-glutamic acid-N,N-diacetic acid (GLDA) and salts thereof are known to be very effective builder replacements for phosphates in detergent formulations, especially detergents for use in ware washing machines such as ADW formulations. Their excellent cleaning performance, even in hard water conditions, confers advantages over other P-free builders.

However their use is not completely without drawbacks. For one, these compounds have been found to have an adverse effect on dye stability in detergents.

Dye stability, while not critical to the functional action of the detergents, is a major concern for consumers. Consumers are reluctant to purchase or trust products when the colour is uneven, weakening or mottled. This is because these effects cause the consumer to believe that the product may be going off or expiring, or just providing a weakened cleaning performance. The problem is particularly acute when the product is provided inside a transparent or translucent container; the transmission of light through the container to the product can accelerate the degradation process, and the resulting discoloured product is easily visible to the consumer.

In WO 2014/037746, a solution to this problem was found for MGDA through formulating it in a non-aqueous liquid, gel or paste formulation. However, the problem has still not been solved for aqueous formulations. Sometimes the skilled person will want to use an aqueous composition, e.g. to incorporate detergent ingredients which are difficult to formulate in the non-aqueous state. Highly aqueous formulations can be contained within non-water-soluble containers without concerns about dissolution of the container. The consumer can pour the required dose of detergent from the container into the ware washing machine. Such products will be subject to different technical requirements than liquid products in monodose form, such as different rheological requirements.

It is the object of the present invention to solve this problem.

CA 2849358 discloses the inclusion of polyethyleneimine in aminocarboxylate-containing dishwasher detergents, for the purpose of inhibiting glass corrosion. Dye stability is not discussed in this document.

### STATEMENTS OF INVENTION

In a first aspect, the invention provides a detergent composition, preferably an automatic dishwasher (ADW) composition comprising a gel or liquid detergent composition wherein the gel or liquid composition comprises an aminocarboxylate builder between 5 and 60% by weight, a dye and less than 5% by weight of a polyalkyleneimine.

In a second aspect, the invention provides a composition as recited in claim 1.

In a third aspect, the invention provides a product comprising the composition according to the invention in its first or second aspect, provided in a water-insoluble container.

In a fourth aspect, the invention provides a method of automatic dishwashing comprising supplying a composition according to the invention in its first or second aspect to an automatic dishwashing machine, and washing wares in the machine using the composition.

In a fifth aspect, the present invention involves the use of a polyalkyleneimine in a detergent composition comprising an aminocarboxylate builder and a dye to prevent degradation of the dye.

### DETAILED DESCRIPTION

In the following section, embodiments discussed apply equally to all aspects of the invention unless the context dictates otherwise. Amounts quoted are by weight (wt %) unless stated otherwise. References to MGDA and GLDA encompass the salt forms of these compounds, unless the context dictates otherwise.

It has been surprisingly found by the inventors that small amounts of polyalkyleneimines added to liquid or gel detergent compositions containing aminocarboxylate builders and dyes can completely overcome the colour stability problems. This is particularly useful when the composition is an aqueous composition. Preferably the detergent composition is an automatic dishwashing (ADW) detergent composition.

The mechanism of action of the polyalkyleneimines on the dye/builder system is not well understood. Nevertheless, its advantageous effect is evidenced herein.

### Polyalkyleneimine

Preferably the composition comprises the polyalkyleneimine in an amount of less than 0.05 wt %, less than 0.04 wt %, less than 0.03 wt %, or less than 0.02 wt %. Preferably, the lowest amount of the polyalkyleneimine to achieve effective dye stabilising results will be used.

Preferably, the polyalkyleneimine is a polyethyleneimine (PEI). Any PEI may be used, but it is preferably a homopolymeric polyethyleneimine. The PEI may be branched or linear, but preferably it is branched.

While it has been found that the PEI used may have any formula weight for effectiveness, preferably the PEI has a lower formula weight (FW). In an embodiment, the PEI has a FW between 100 and 50,000, between 400 and 25,000, between 800 and 10,000, or between 1000 and 3000.

In an embodiment, the polyalkyleneimine comprises a polyethyleneimine (PEI) and preferably the PEI comprises less than 1% by weight of the composition, preferably less than 0.5% by weight, preferably less than 0.25% by weight of the composition and most preferably less than 0.02% by weight of the composition. Preferably the PEI has a molecular weight between 100 and 2500, preferably 200 and 1500 and most preferably between 400 and 1200.

In a preferred embodiment, the polyalkyleneimine has a molecular weight between 100 and 2500, between 200 and 1500, between 400 and 1200, or between 700 and 900. A molecular weight of 800 is particularly suitable. The molecular weight is suitably determined by light scattering

Polyethyleneimines are commercially available, for example Lupasol™ FG which is supplied by BASF.

### Aminocarboxylate

The aminocarboxylate builder is present between 5 and 60% by weight of the detergent composition. Preferably the aminocarboxylate builder comprises between 7 and 30% by weight of the detergent composition, preferably between 10 and 25% by weight and more preferably between 12 and 20% by weight.

In an embodiment, the composition comprises 6 to 35 wt %, 7 to 30 wt %, 10 to 25 wt %, 12 to 20 wt %, or 13 to 15 wt %, of the aminocarboxylate builder.

Any aminocarboxylate builder may be used in the present invention. Suitable builders are described in U.S. Pat. No. 6,426,229 which are incorporated by reference herein. Particularly suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA) and alkali metal salts or ammonium salts thereof.

Preferred aminocarboxylate builders are methylglycine-N,N-diacetic acid, glutamic acid diacetic acid, or salts or mixtures thereof. Preferred are alkali metal salts of these compounds, preferably sodium or potassium salts thereof, preferably sodium salts thereof. Commercial examples of GLDA suitable for use in the present invention include Dissolvine® GL as provided by AkzoNobel; commercial examples of MGDA suitable for use in the present invention include Trilon® M as provided by BASF.

Preferably, the aminocarboxylate builder is in a dissolved state in the composition. Conveniently, an aqueous solution of the aminocarboxylate builder may be used as a raw ingredient in the preparation of the composition.

### Dye

Any commercially available dye suitable for use in detergent compositions may be utilised in the present invention. Preferably the dye is a known detergent-stable dye.

In an embodiment, the dye is a water-soluble organic dye. Preferably, it is provided in a dissolved state in the composition.

In an embodiment, it is an arylmethane (e.g. triarylmethane or diarylmethane) dye, anthraquinone dye, azo dye, phthalocyanine dye, nitroso dye, quinone-imine dye, thiazole dye, or xanthene dye.

Non-limiting examples of suitable dyes include Phthalocyanine Green, Acid Blue 9 (Basacid Blue 756), Basacid Blue 762, Sanolin Blue E-HRL, Sanolin Yellow Tartrazine X90, Iragon Blue ABL 9, Iragon Blue DBL 86, Puricolor Orange AOR 7, Iragon Red ARE 52, Sanolin Blue E-HRL, Basacid Blue 762, FC&C Yellow #5, Ponceau Red (Vitasyn Ponceau 4 RC 82), Acid Green 1 (Iragon Green AGR1), Pigment Red 57:1, Ariabel Rubicon Red, Acid Blue 80 (Iragon Blue ABL 80), Solvent Blue 104 (Solvaperm Blue 2B) and Sanolin Green R3GL (Reactive Green 12).

Typically the dye constitutes less than 1% by weight of the detergent composition. Preferably it makes up less than 0.5% by weight of the detergent composition. Preferably the dye is present between 0.001 and 0.5% by weight of the detergent composition.

### Water

The liquid or gel detergent formulation is preferably an aqueous gel or liquid formulation. The water content may be as high as 70% by weight. In an embodiment, the composition comprises at least 20 wt %, at least 25 wt %, at least 30 wt %, at least 35 wt %, at least 40 wt %, or at least 45 wt %, water. The water content of the formulation may be between 10 and 60% by weight, more preferably 20 to 55% and most preferably between 25 and 50%.

### Co-Builders

Further builders or co-builders may also be included in the composition. These may be either a phosphorous-containing builder or a phosphorous-free builder as desired. In many jurisdictions, phosphate builders are banned. In an embodiment, the composition is phosphate-free.

If phosphorous-containing builders are also to be used, it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15% by weight to 60% by weight, such as from 20% by weight to 50% by weight or from 25% by weight to 40% by weight.

If additional phosphorous-free builder is included, it is preferably chosen from succinate based compounds. The terms ‘succinate based compound’ and ‘succinic acid based compound’ are used interchangeably herein. Conventional amounts of the succinate based compounds may be used, typically in the range of from 5% by weight to 80% by weight, such as from 15% by weight to 70% by weight or from 20% by weight to 60% by weight. The compounds may be used individually or as a mixture.

Further preferred succinate compounds are described in U.S. Pat. No. 5,977,053 and have the formula;

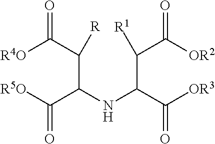

in which R, R¹, independently of one another, denote H or OH, R², R³, R⁴, R⁵, independently of one another, denote a cation, hydrogen, alkali metal ions and ammonium ions, ammonium ions having the general formula R⁶ R⁷ R⁸ R⁹ N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium iminosuccinate. Iminodisuccinic acid (IDS) and (hydroxy)iminodisuccinic acid (HIDS) and alkali metal salts or ammonium salts thereof are especially preferred succinate based builder salts.

The phosphorous-free co-builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

An especially preferred phosphorous-free builder is a citrate salt, especially sodium citrate.

Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders are disclosed in WO 95/01416, to the contents of which express reference is hereby made.

If present, the co-builder is preferably present between 5 and 40% by weight of the composition, more preferably between 7 and 25% by weight and most preferably between 10 and 20% by weight.

Preferably, the total amount of builder present in the composition is at least 20% by weight, and most preferably at least 22% by weight, at least 25% by weight, at least 28 wt %, or at least 30 wt %. Preferably it is present in an amount of up to 70% by weight, preferably up to 60% by weight, more preferably up to 45% by weight. The actual amount used in the compositions will depend upon the nature of the builder used. If desired a combination of phosphorous-containing and phosphorous-free builders may be used.

### Bleaches

The detergent compositions may comprise a bleach component or material. For example, the bleach material may comprise and oxygen or chlorine based bleach. The bleach material may be selected from any conventional bleach material known to be used in detergent compositions. The material may comprise the active bleach species itself or a precursor to that species. For example, the bleach material may comprise at least one inorganic peroxide or organic peracid or a chlorine based bleach including derivatives and salts thereof or mixtures thereof. Inorganic peroxides include percarbonates, perborates, persulphates, hydrogen peroxide and derivatives and salts thereof. The sodium and potassium salts of these inorganic peroxides are suitable, especially the sodium salts. Sodium percarbonate and sodium perborate are most preferred, especially sodium percarbonate.

The detergent compositions may also comprise bleach additives or bleach activation catalysts. The composition may comprise one or more bleach activators or bleach catalysts depending upon the nature of the bleaching compound. Any suitable bleach activator may be included, for example TAED if this is desired for the activation of the bleach material. Any suitable bleach catalyst may be used for example manganese acetate or dinuclear manganese complexes such as those described in EP-A-1,741,774.

However, bleaches may be liable to degrade or discolour the dye in the composition, especially when both are in dissolved form and can come into intimate contact with each other. In a preferred embodiment, therefore, the composition is free of bleach. In the case of bleach-free compositions, the composition need not contain any bleach activator or catalyst either.

### Surfactants

The detergent compositions of the invention may include surfactants. Any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, when the composition comprises bleach, bleach-stable surfactants are preferred.

In the case of ADW compositions, it is preferred to minimise the amount of anionic surfactant. Preferably the composition comprises no more than 2 wt %, no more than 1 wt %, or no, anionic surfactant. Preferably the composition comprises no more than 2 wt %, no more than 1 wt %, or no, ionic surfactant of any type. Non-ionic surfactants are especially preferred instead for automatic dishwashing compositions.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30% by weight, preferably more than 50% by weight, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]X[CH₂CH₂O]Y[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]X[CH₂]kCH(OH)[CH₂]jOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2, each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³, H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R₃)O]XCH₂CH(OH)CH₂OR²

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

In an embodiment, the non-ionic surfactants are present in the detergent composition in an amount of from 0.1% by weight to 20% by weight, more preferably 1% by weight to 15% by weight, such as 2% to 10% by weight based on the total weight of the detergent composition. In an embodiment, the composition comprises no more than 2 wt % surfactant, no more than 1 wt % surfactant, or no surfactant at all. The compositions of the invention can surprisingly provide effective cleaning despite having such low surfactant levels.

### Pourability

The liquid or gel compositions of the invention suitably have a viscosity in the range allowing them to be poured easily from a container at room temperature. A liquid or gel which has too low a viscosity may pour too quickly and the consumer may easily spill it. In contrast, a composition which is too viscous may be difficult to pour. The appropriate viscosity may be obtained by including a thickener in the composition. Suitable thickeners include xanthan gum. Organic solvents, preferably those miscible with water, can also be included in the composition, including glycols, such as monopropylene glycol and dipropylene glycol.

### Other Ingredients

The skilled person will be aware of the kinds of ingredients needed to form effective ADW (automatic dishwashing) detergent compositions. The detergent compositions may comprise any other suitable ingredients known in the art.

For example, the detergent compositions may also include enzymes. It is preferred that the enzyme is selected from proteases, lipases, amylases, cellulases and peroxidases, with proteases and amylases, especially proteases being most preferred. It is most preferred that protease and/or amylase enzymes are included in the compositions according to the invention as such enzymes are especially effective for example in dishwashing detergent compositions. Any suitable species of these enzymes may be used as desired. More than one species may be used.

The detergent compositions may comprise one or more anti-corrosion agents, especially when the detergent compositions are for use in automatic dishwashing operations. These anti-corrosion agents may provide further benefits against corrosion of glass and/or metal and the term encompasses agents that are intended to prevent or reduce the tarnishing of non-ferrous metals, in particular of silver and copper.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO4, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Zinc acetate, zinc sulphate and Ce(NO₃)₃. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

Any conventional amount of the anti-corrosion agents may be included. However, it is preferred that they are present in an total amount of from 0.01% by weight to 5% by weight, preferably 0.05% by weight to 3% by weight, more preferably 0.1% by weight to 2.5% by weight, such as 0.2% by weight to 2% by weight based on the total weight.

Polymers intended to improve the cleaning performance of the detergent compositions may also be included therein. For example sulphonated polymers may be used. Preferred examples include copolymers of CH2=CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

When a sulfonated polymer is present, it is preferably present in an amount of at least 0.1% by weight, preferably at least 0.5% by weight, more preferably at least 1% by weight, and most preferably at least 3% by weight, up to 40% by weight, preferably up to 25% by weight, more preferably up to 15% by weight, and most preferably up to 10% by weight.

The detergent composition may also comprise one or more foam control agents. Suitable foam control agents for this purpose are all those conventionally used in this field, such as, for example, silicones and their derivatives and paraffin oil. The foam control agents are preferably present in amounts of 0.5% by weight or less.

The detergent compositions may also comprise minor, conventional, amounts of preservatives, fragrance, etc.

pH

The detergent compositions may also comprise a source of acidity or a source of alkalinity, to obtain the desired pH, on dissolution, especially if the composition is to be used in an automatic dishwashing application. A source of acidity may suitably be any suitable acidic compound for example a polycarboxylic acid. For example a source of alkalinity may be a carbonate or bicarbonate (such as the alkali metal or alkaline earth metal salts). A source of alkalinity may suitably be any suitable basic compound, for example any salt of a strong base and a weak acid. When an alkaline composition is desired, silicates are amongst the suitable sources of alkalinity. Preferred silicates are sodium silicates such as sodium disilicate, sodium metasilicate and crystalline phyllosilicates. In an embodiment, the composition is free of silicate.

In an embodiment, the composition has a pH between 6 and 13, between 6.5 and 12, between 7 and 11 or between 8 and 10.

### Product Format

In the broadest aspect of the invention, the composition may be a monodose composition, and may be housed within a water soluble film or container, preferably a polyvinyl alcohol (PVOH) film or container. By monodose is meant that the compositions are presupplied in measured amounts suitable for a single wash cycle.

It may be a single phase liquid or gel monodose composition. Alternatively, the liquid or gel composition may form one phase of a multiphase monodose composition, having at least two or more separate compositions, preferably at least three or more separate compositions. The multiphase composition may comprise one or more different phases including powder, granules, and compressed solids. The monodose may comprise a tablet with a gel portion or layer.

Preferably, however, the detergent composition consists of the gel or liquid composition. The composition is pourable and may be single phase or contain suspended solids, but it is preferably homogeneous overall.

In an aspect of the invention, the detergent composition is stored in a water-insoluble container, such as a bottle. The liquid or gel composition is preferably stored in a container with UV filtering. The container may be made of a (preferably colourless) transparent or translucent material, such as a plastics material.

### EXAMPLES

The invention is further described with reference to the following non-limiting examples. Further examples within the scope of the invention will be apparent to the person skilled in the art.

Six sample detergent compositions were prepared to demonstrate the invention.

### Example 1—MGDA Containing Gel

| | |
|---|---|
| Water (soft) | 48.732 |
| Perfume | 0.300 |
| Thickener | 0.300 |
| Glycols | 7.000 |
| Amylase | 0.300 |
| Mirapol Surf-S 480 PF | 1.300 |
| Trilon M Solution | 17.000 |
| purified (MGDA) | |
| Trisodium Citrate | 15.000 |
| Lupasol FG (PEI) | 0.015 |
| Dye | 0.003 |
| Sulphonated polymer | 6.000 |
| Preservative | 0.050 |
| Protease Liquid | 3.000 |
| Formic Acid | 1.000 |
| Total | 100.00 |
| | wt % |

### Example 2 GLDA Containing Gel

| | |
|---|---|
| Water (soft) | 50.955 |
| Thickener | 0.400 |
| Glycols | 10.000 |
| Dissolvine GL-45- | 15.000 |
| SLA (GLDA) | |
| Amylase | 0.300 |
| Protease Liquid | 3.000 |
| Sulfonated polymer | 3.500 |
| Trisodium Citrate | 15.000 |
| Mirapol Surf-S 480 PF | 1.130 |
| Lupasol FG (PEI) | 0.015 |
| Sanolin Blue E-HRL | 0.200 |
| (1% diluted) | |
| Preservative | 0.100 |
| Perfume | 0.400 |
| Total | 100.00 |
| | wt % |

### Comparative Example 3

As Example 1, minus PEI and with the balance made up by water.

### Comparative Example 4

As Example 2, minus PEI and with the balance made up by water.

### Comparative Example 5

As Example 1, minus PEI and MGDA, with the balance made up by water.

### Comparative Example 6

As Example 2, minus PEI and GLDA, with the balance made up by water.

The six example gel detergents were put through a Sun test to simulate the effects of sunlight on the formulation with time.

### Sun Test

Atlas Suntester XLS+ 765 W/m² daylight lamp

T=50° C. (black plate standard), chamber temp. 38-42° C.

Test time: 8 hrs

### Results

### Test 1

Examples 1 and 2 and Comparative Examples 3 and 4 were placed in clear plastic bottles and subjected to the Sun test as described above.

Examples 1 and 2 were unaffected by the test, homogenous in appearance and dye strength appeared unchanged to the naked eye. Comparative Examples 3 and 4 without PEI both became highly discoloured and mottled in appearance.

### Test 2

Comparative Examples 3 and 4 were then placed in bottles with UV filters and subjected to the same Sun test.

The results were the same as for Test 1: both became highly discoloured; the UV filter had no impact.

### Test 3

To confirm that the effects shown were due to the presence of the aminocarboxylate builders, the Sun tests were repeated on both Comparative Examples 5 and 6 in standard bottles.

In both the tests with the MGDA and GLDA removed, the formulations maintained their original coloured appearance throughout the Sun test.

This test confirms that it is the aminocarboxylate builders that are the cause of the discolouration and that the addition of a polyalkyleneimine that stops this effect.

1. An aqueous gel or liquid detergent composition comprising:
5 to 60 wt % of an aminocarboxylate builder;
a dye; and
polyalkyleneimine;
wherein the polyalkyleneimine is present in an amount of less than 5 wt % of the composition.

2. The detergent composition as claimed in claim 1, wherein the composition is bleach free.

3. The detergent composition as claimed in claim 1, wherein the composition comprises the polyalkyleneimine in an amount of less than 0.05 wt %.

4. The detergent composition as claimed in claim 1, wherein the polyalkyleneimine has a molecular weight between 100 and 2500.

5. The detergent composition as claimed in claim 1, wherein the composition comprises 6 to 35 wt % of the aminocarboxylate builder.

6. The detergent composition as claimed in claim 1, wherein the composition comprises a citrate salt.

7. The detergent composition as claimed in claim 1, wherein the composition comprises at least 20 wt % water.

8. The detergent composition as claimed in claim 1, wherein the composition comprises no more than 2 wt % surfactant.

9. The detergent composition as claimed in claim 1, wherein the composition comprises 0.0001 and 0.5 wt % of the dye.

10. The detergent composition as claimed in claim 1, wherein the composition comprises a thickener.

11. The detergent composition as claimed in claim 1, wherein the composition comprises one or both of monopropylene glycol and dipropylene glycol.

12. A product comprising the detergent composition as claimed in claim 1, provided in a water-insoluble container.

13. The product as claimed in claim 12, wherein the container is made of a transparent or translucent material.

14. A method of automatic dishwashing comprising:
supplying a composition as claimed in claim 1 to an automatic dishwashing machine; and
washing wares in the dishwashing machine using the composition.

15. (canceled)

16. The detergent composition as claimed in claim 1, wherein the polyalkyleneimine comprises a polyethyleneimine.

17. The detergent composition as claimed in claim 1, wherein the polyalkyleneimine has a molecular weight between 700 and 900.

18. The detergent composition as claimed in claim 1, wherein the polyalkyleneimine is a homopolymeric polyethyleneimine.

19. The detergent composition as claimed in claim 1, wherein the polyalkyleneimine is a branched polyethyleneimine.

20. The detergent composition as claimed in claim 1, wherein the aminocarboxylate builder comprises one of L-glutamic acid-N,N-diacetic acid, methylglycine-N,N-diacetic acid, and a salt thereof.

21. The detergent composition as claimed in claim 1, wherein the aminocarboxylate builder is in a dissolved state in water in the composition.

22. The detergent composition as claimed in claim 1, wherein the composition is phosphate free.

23. The detergent composition as claimed in claim 1, wherein the total builder amount in the composition is at least 20 wt %.

24. The detergent composition as claimed in claim 1, wherein the dye is a water-soluble organic dye that is provided in a dissolved state in the composition.

25. The product as claimed in claim 12, wherein the container is provided with a UV filter.
